(19) United States
(12) Patent Application Publication
(10) Pub. No.: US 2026/0329148 A1
(43) Pub. Date: Oct. 22, 2026

(54) Trail Camera Cover Device

(71) Applicant: Scott Camp, Madisonville, LA (US)

(72) Inventor: Scott Camp, Madisonville, LA (US)

(21) Appl. No.: 19/468,252

(22) Filed: Feb. 3, 2026

Related U.S. Application Data
(63) Continuation-in-part of application No. 18/666,315, filed on May 16, 2024.
(60) Provisional application No. 63/601,242, filed on Nov. 21, 2023.

(51) Int. Cl. G03B 11/04; G03B 17/56

(52) U.S. Cl. CPC G03B 11/045; G03B 17/561; G03B 17/566

(57) ABSTRACT

A trail camera cover device is provided. The device is comprised of a body that can be attached to a trail camera. The body has at least two side walls, a rear wall, and a top wall that encloses the top portion of a trail camera. The top wall is curved which prevents precipitation from collecting on the trail camera. The body may also be comprised of at least one opening to accommodate trail camera mounting structures. Further, the body may have structures intended to minimize reflections from the camera when capturing images and videos.

### CROSS-REFERENCE TO RELATED APPLICATION

The present application is a continuation-in-part patent application of, and claims priority to and the benefit of, U.S. Patent Application No. 18/666,315, which was filed on May 16, 2024, and which claims priority to and the benefit of U.S. Provisional Application No. 63/601,242, which was filed on November 21, 2023, both of which are incorporated herein by reference in their entirety.

### FIELD OF THE INVENTION

The present invention relates generally to the field of trail cameras. More specifically, the present invention relates to a protective cover for a trail camera that protects the trail camera during use. Accordingly, the present disclosure makes specific reference thereto. Nonetheless, it is to be appreciated that aspects of the present invention are also equally applicable to other like applications, devices, and methods of manufacture.

### BACKGROUND

Moisture and precipitation from rain, snow, or fog, have the potential to penetrate the intricate electronics of a trail camera, potentially leading to significant damage or complete malfunction. When moisture accumulates, it can render a trail camera inoperative, primarily due to the build-up of water, ice, or snow on critical components such as the camera's lens, flash, or motion detector. This accumulation not only hinders the camera's functionality but can also lead to the production of images that are blurry, distorted, or entirely unusable. Factors such as sun glare or condensation on the lens further exacerbate this issue, compromising the quality of the photographs.

In addition to moisture-related problems, trail cameras are often subject to interference from local wildlife. Birds and other animals, in their natural activities, may defecate on the cameras. This may not only cover the camera and prevent the camera from capturing images and video but can also lead to corrosive damage due to the acidic nature of the waste that can potentially ruin sensitive parts of the camera such as the lens. In some cases, animals may even cause physical destruction to the camera lens, rendering the device useless.

Furthermore, the operational lifespan of trail cameras is heavily influenced by these environmental factors. The harshness of the elements, ranging from extreme temperatures to precipitation and wildlife interactions, can significantly reduce the hours of effective operation. As a result, maintaining and protecting trail cameras from these environmental challenges becomes crucial to ensure their longevity and effectiveness in capturing clear, useful images of the trail and animals.

Therefore, there exists a long-felt need in the art for a protective device for a trail camera. There also exists a long-felt need in the art for a trail camera cover device. Further, there exists a long-felt need in the art for a trail camera cover device that can be attached to a trail camera to protect the camera against precipitation and animals.

The subject matter disclosed and claimed herein, in one embodiment thereof, comprises a trail camera cover device. The device is comprised of a body that can be attached to a trail camera. The body may have at least two side walls, a rear wall, and a top wall that encloses the top portion of a trail camera. The top wall may be curved, flat, or multi-angular which prevents precipitation from collecting on the trail camera. The body may also be comprised of at least one opening to accommodate trail camera mounting structures. Further, the body may have structures intended to minimize reflections from the camera when capturing images and videos.

In this manner, the trail camera cover device of the present invention accomplishes all the foregoing objectives and provides a protective device for a trail camera. More specifically, the device can be attached to a trail camera to protect the camera against precipitation and animals.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trail camera cover device comprised of a body that can be used to cover a trail camera. The body may be comprised of at least two side walls connected by at least one rear wall which are further connected by at least one top wall. The top wall rests above the top of a trail camera and may be curved, flat, or multi-angular such that precipitation, moisture, etc., can run off of the body without pooling. The top wall is comprised of at least one lip that may be beveled in order to prevent reflection from a trail camera flash from being captured in photos/videos from the trail camera.

The rear wall may be comprised of at least one interior bracket that contacts the top of a trail camera once the device is installed on said camera. The bracket acts as a stop point for the camera, an alignment tool for the body, and a support bracket that provides rigidity. To allow the device to be further secured to and aligned on a trail camera, may have a fastener or fasteners such as, but not limited to, a tether strap can be placed through at least one strap opening and around the trail camera. The rear wall (and/or side wall) may be comprised of at least one cutout that allows features of a trail camera such as, but not limited to, mounting features to remain accessible when the device is attached to the camera.

Accordingly, the trail camera cover device of the present invention is particularly advantageous as it provides a protective device for a trail camera. More specifically, the device can be attached to a trail camera to protect the camera against precipitation and animals. In this manner, the trail camera cover device provides a solution to protecting trail cameras.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a trail camera cover device of the present invention in accordance with the disclosed architecture;

FIG. 2 illustrates a rear perspective view of one potential embodiment of a trail camera cover device of the present invention in accordance with the disclosed architecture;

FIG. 3 illustrates a side perspective view of one potential embodiment of a trail camera cover device of the present invention in accordance with the disclosed architecture;

FIG. 4 illustrates a perspective view of one potential embodiment of a trail camera cover device of the present invention while the device is resting on a rear wall in accordance with the disclosed architecture;

FIG. 5 illustrates a side perspective view of one potential embodiment of a trail camera cover device of the present invention in accordance with the disclosed architecture;

FIG. 6 illustrates a side exploded view of one potential embodiment of a trail camera cover device of the present invention while above a trail camera in accordance with the disclosed architecture;

FIG. 7 illustrates a bottom perspective exploded view of one potential embodiment of a trail camera cover device of the present invention in accordance with the disclosed architecture; and

FIG. 8 illustrates a side perspective view of one potential embodiment of a trail camera cover device of the present invention while attached to a trail camera in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a protective device for a trail camera. There also exists a long-felt need in the art for a trail camera cover device. Further, there exists a long-felt need in the art for a trail camera cover device that can be attached to a trail camera to protect the camera against precipitation and animals.

The present invention, in one exemplary embodiment, is comprised of a trail camera cover device. The device is comprised of a body that can be used to cover a trail camera, wherein the body may have at least two side walls connected by at least one rear wall which are further connected by at least one top wall. The top wall rests above the top of a trail camera and may be curved, angled, or multi-angular such that precipitation, moisture, etc., can run off of the body without pooling. The top wall is comprised of at least one lip. The lip may be beveled in order to prevent reflection from a trail camera flash from being captured in photos/videos from the trail camera.

The rear wall may be comprised of at least one interior bracket that contacts the top of a trail camera once the device is installed on said camera. The bracket acts as a stop point for the camera, an alignment tool for the body, and a support bracket that provides rigidity. To allow the device to be further secured to and aligned on a trail camera, at least one fastener such as, but not limited to, a tether strap can be placed through at least one strap opening and around the trail camera. The rear wall (and/or side wall) may be comprised of at least one cutout that allows features of a trail camera such as, but not limited to, mounting features to remain accessible when the device is attached to the camera.

Accordingly, the trail camera cover device of the present invention is particularly advantageous as it provides a protective device for a trail camera. More specifically, the device can be attached to a trail camera to protect the camera against precipitation and animals. In this manner, the trail camera cover device provides a solution to protecting trail cameras.

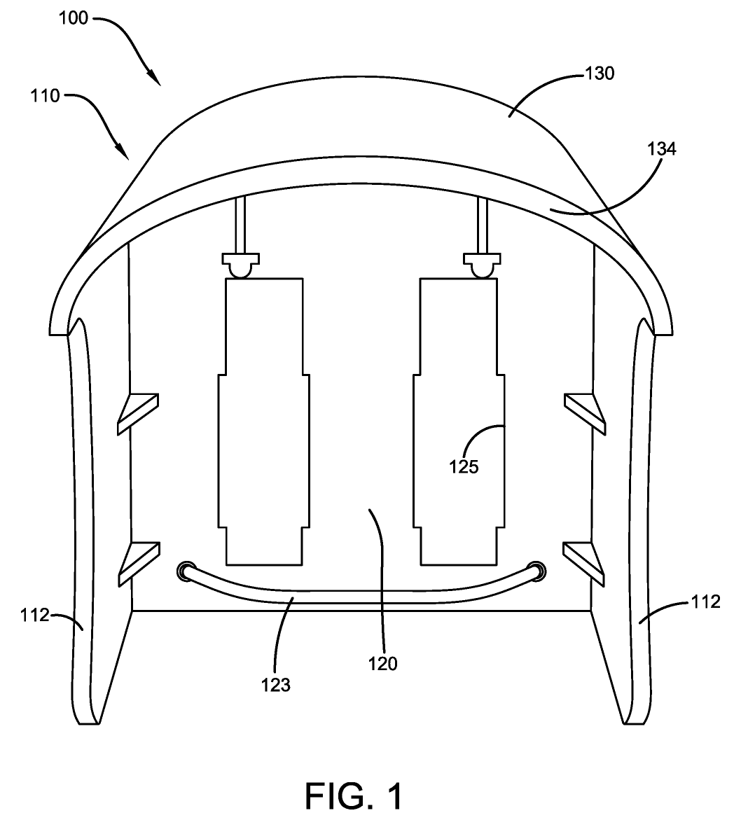

Referring initially to the drawings, FIG. 1 illustrates a front perspective view of one potential embodiment of a trail camera cover device 100 of the present invention in accordance with the disclosed architecture. The device 100 is comprised of a body 110 that can be used to cover a trail camera. The body 110 is comprised of at least two side walls 112 connected by at least one rear wall 120. The rear wall 120 and side walls 112 are further connected by at least one top wall 130.

The top wall 130 rests above the top of a trail camera. The top wall 130 is curved such that precipitation, moisture, etc., can run off of the body 110 without pooling. The top wall 130 may have at least one plane to accommodate any shape and style of trail camera. The top wall 130 is comprised of at least one lip 134. The lip 134 reinforces the edge of the top wall 130. Any portion of the lip 134 may be beveled in order to prevent reflection from a trail camera flash from being captured in photos/videos from the trail camera. The top wall 130 may be any size and shape and may extend any distance over the walls 112, 120 at any single or multi-plane angle.

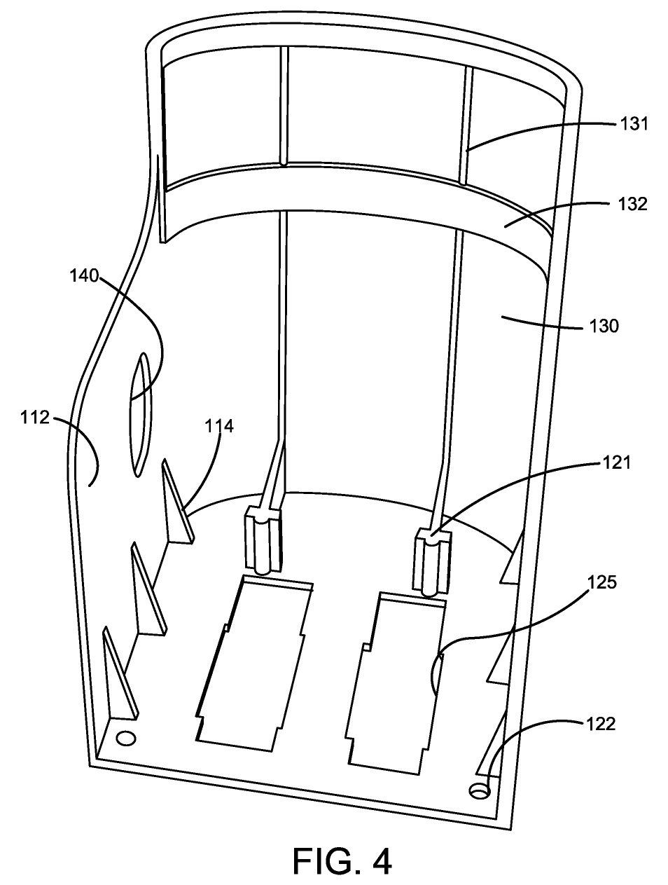

The top wall 130 may further be reinforced via at least one spine 131 that may be present on the interior and/or exterior of the device 100. The spine 131 is preferably, but not limited to, a longitudinal spine that ensures the body 110 remains rigid, thus reducing torque and preventing premature wear due to expansion and contraction of the body 110 material that occurs during temperature fluctuation. The top wall 130 may also have at least one reinforcing member 132 (that may be present on the interior and/or exterior of the device 100) that may be arranged in any direction and pattern to provide structural rigidity/stability to the body 110. The member 132 is preferably positioned near the intersection point of the side walls 112 and top wall 130. Any portion of the member 132 may also be beveled/have a beveled edge in order to prevent reflection from a trail camera flash from being captured in photos/videos from the trail camera. Similarly, the side wall 112 may be comprised of at least one reinforcement member 114 (that may be present on the interior and/or exterior of the device 100), as seen in FIG. 4. The member 114 may be any size, shape, and configuration but is preferably triangular and connects the side wall 112 to the rear wall 120 while providing stiffening and enhanced strength.

The rear wall 120 may be comprised of at least one interior bracket 121. The bracket 121 may be any size, shape, and configuration. The bracket 121 contacts the top of a trail camera once the device 100 is installed on said camera, wherein the bracket 121 acts as a stop point for the camera, an alignment tool for the body 110, and a support bracket that provides rigidity. To allow the device 100 to be further secured to and aligned on a trail camera, at least one fastener 123 such as, but not limited to, a tether strap can be placed through at least one strap opening 122 and around the trail camera.

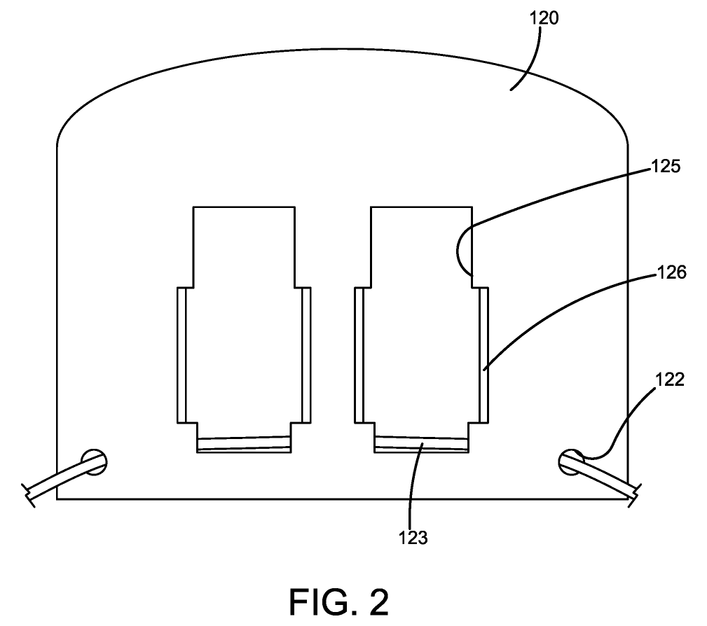

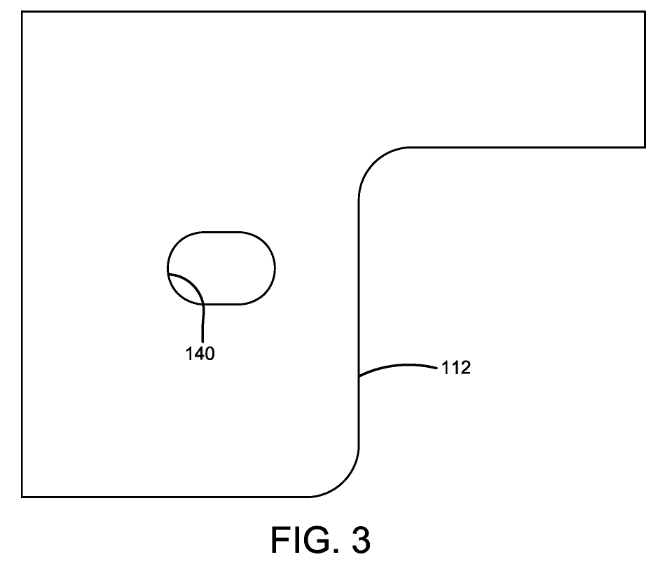

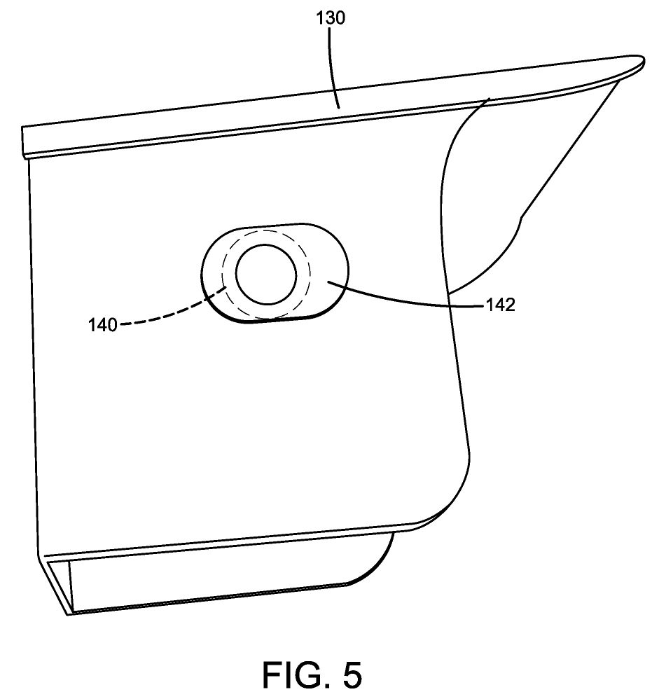

The rear wall 120 (and/or side wall 112) may be comprised of at least one cutout 125 (as seen in FIG. 2) that allows features of a trail camera such as, but not limited to, mounting features to remain accessible when the device 100 is attached to the camera. The cutout 125 may be any shape, size, and configuration to accommodate any type of trail camera. The cutout 125 may also be comprised of at least one beveled edge 126 that accommodates and secures strap mounting systems used with trail cameras. Any portion of the body 110 may also be comprised of at least one opening 140 for an antenna of the trail camera, as seen in FIG. 3. In one embodiment, the opening 140 may be sealed with at least one rubber plug (having no opening) and/or grommet (having an opening) 142 if no antenna is present, as seen in FIG. 5.

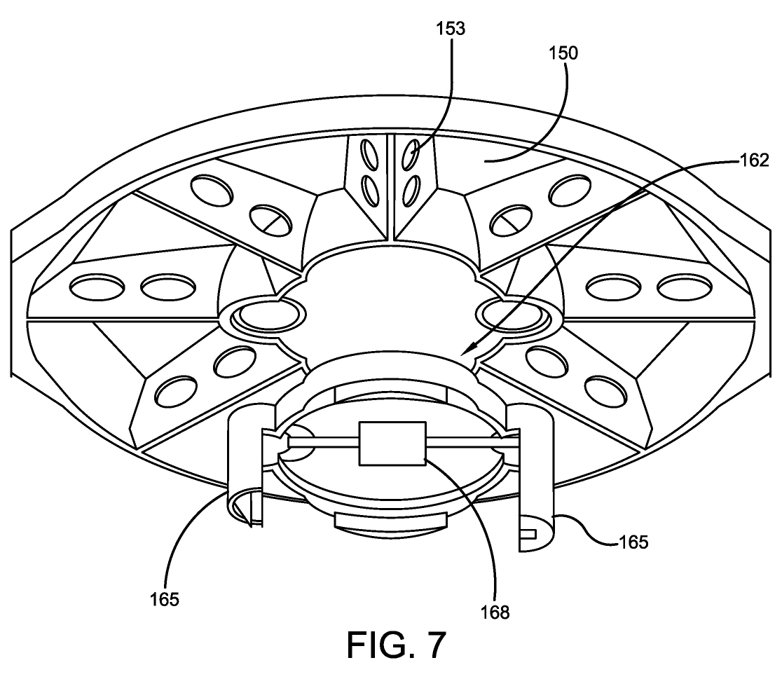

In one embodiment, the top wall 130 may be a rounded circular shape that may further be convex. In various embodiments, the top wall 130 may also be shaped in alternate curved profiles such as dome-shaped, elliptical, or arcuate geometries, provided the form of the top wall 130 directs airflow in a manner conducive to stabilization of the device 100. The bottom surface 150 of the top wall 130 may be comprised of a plurality of air channels 152, as seen in FIG. 7. The air channels 152 may be linear, curved, serpentine, helical, or randomly oriented, and may be formed through molding, machining, or additive manufacturing. The air channels 152 may be arranged in a grid, spiral, radial, or irregular pattern and may be distributed in varying densities across the bottom surface 150. In one embodiment, the channels 152 are comprised of a secondary wind openings 153 to further allow for wind pass through. The configuration of the air channels 152 may be selected to disrupt laminar airflow and negate Bernoulli’s principle of lift on the top wall 130, thereby reducing the risk of the device 100 unintentionally lifting from a trail camera 154 due to aerodynamic forces in outdoor environments.

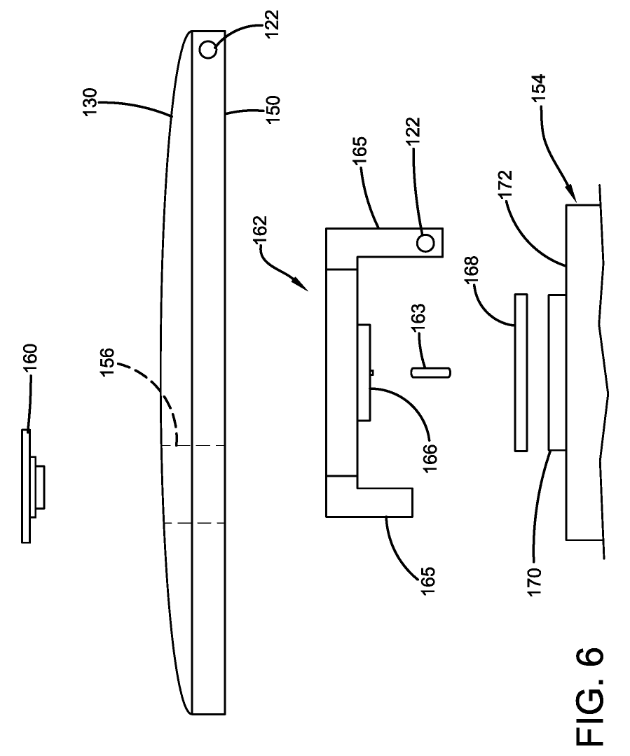

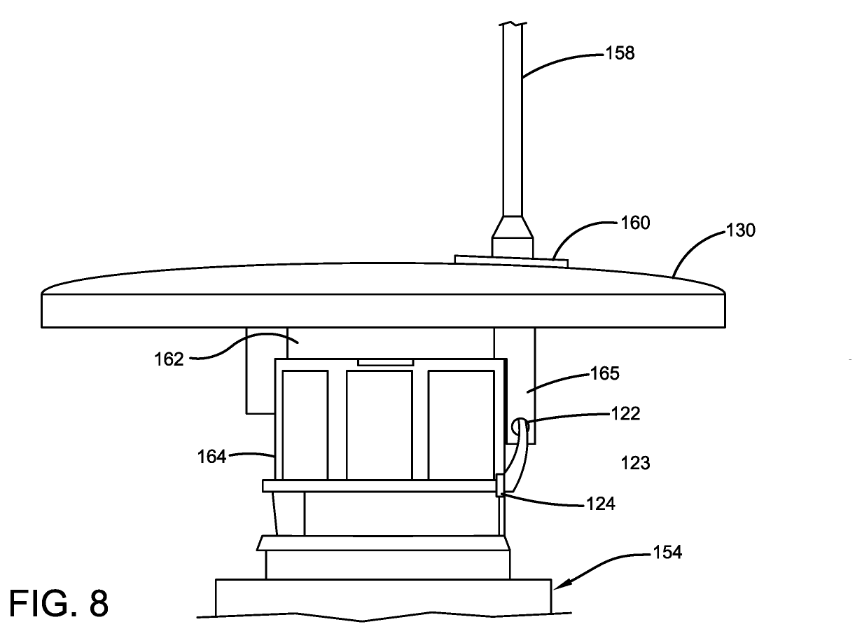

The top wall 130 may further be comprised of an opening 156 that permits an antenna 158 of the trail camera 154 to extend through the top wall 130, as seen in FIGS. 6 and 8. In one embodiment, the opening 156 is comprised of a grommet 160. The grommet 160 may secure the antenna 158 within the opening 156 and may prevent precipitation from passing through the opening 156 into the interior region above the trail camera 154.

At least one camera adapter 162 may be integrally formed on the bottom surface 150 of the top wall 130. In an alternative embodiment, the camera adapter 162 may be removably attached to the bottom surface 150 via at least one fastener 163 (as seen in FIG. 6), such as but not limited to a screw, adhesive, tongue fastener, groove fastener, etc. The adapter 162 may be shaped and configured to attach to existing structures 164 located on the exterior of the trail camera 154. Such structures 164 may include surfaces, grooves, channels, lips, openings, etc. In various embodiments, the adapter 162 may be specifically shaped and configured to interface with and attach to different structures 164 present on various models of trail cameras 154. In one embodiment, the adapter 162 is comprised of a plurality of legs 165. The legs 165 may extend from the adapter 162 and may press against one or more surfaces of the trail camera 154, as seen in FI. The legs 165 may be resilient or rigid and may provide a clamping or stabilizing function that secures the adapter 162 to the camera 154 with increased surface engagement.

In one embodiment, the adapter 162 may include a receiving surface 166, wherein the receiving surface 166 is flat. The receiving surface 166 may be comprised of at least one fastener 168. The fastener 168 may be configured to attach to a corresponding fastener 170, which may be affixed to or formed on a top surface 172 of the trail camera 154. The fasteners 168, 170 may be comprised of any type of reciprocating fasteners such as but not limited to magnets, hook and loop systems, snap buttons, tongue and groove connectors, etc.

In one embodiment, either the top wall 130 or the camera adapter 162 may be comprised of at least one opening 122. The opening 122 may allow for the use of a fastener 123, such as but not limited to a strap, to secure the device 100 to the trail camera 154, wherein the strap may be comprised of an adjustment fastener 124 such as but not limited to a sliding buckle. In one embodiment, the fastener 123 is a looped strap that can be looped or tied around a portion of camera 154 (as seen in FIG. 8), wherein the circumference of the loop and/or the overall length of the fastener 123 can be adjusted with the adjustment fastener 124.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trail camera cover device” and “device” are interchangeable and refer to the trail camera cover device 100 of the present invention.

Notwithstanding the foregoing, the trail camera cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trail camera cover device 100 as shown in the FIGS. are for illustrative purposes only, and that many other sizes and shapes of the trail camera cover device 100 are well within the scope of the present disclosure. Although the dimensions of the trail camera cover device 100 are important design parameters for user convenience, the trail camera cover device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trail camera cover device comprising:
a body comprised of a top wall, wherein the top wall is comprised of an opening; and
a camera adapter attached to the top wall, wherein the camera adapter is comprised of a first fastener a first leg, and a second leg spaced apart from the first leg.

2. The trail camera cover device of claim 1, wherein the body is comprised of a convex, circular shape.

3. The trail camera cover device of claim 1, wherein the top wall or the camera adapter is comprised of an opening.

4. The trail camera cover device of claim 3, wherein a strap is positioned through the opening.

5. A trail camera cover device comprising:
a body comprised of a top wall, wherein the top wall is comprised of an opening and wherein a grommet is positioned within the opening; and
a camera adapter attached to the top wall, wherein the camera adapter is comprised of a first fastener, a first leg, and a second leg spaced apart from the first leg.

6. The trail camera cover device of claim 5, wherein the camera adapter is comprised of a flat receiving surface.

7. The trail camera cover device of claim 6, wherein the first fastener is positioned on the flat receiving surface.

8. The trail camera cover device of claim 5, wherein the first fastener is comprised of a hook fastener or a loop fastener.

9. The trail camera cover device of claim 5, wherein the first fastener is comprised of a magnet.

10. The trail camera cover device of claim 5, wherein the first fastener is comprised of a tongue or a groove.

11. The trail camera cover device of claim 5, wherein the body is comprised of a convex, circular shape.

12. The trail camera cover device of claim 5, wherein the top wall or the camera adapter is comprised of an opening.

13. The trail camera cover device of claim 12, wherein a strap is positioned through the opening.

14. A trail camera cover device comprising:
a body comprised of a top wall, wherein the top wall is comprised of an opening and wherein a grommet is positioned within the opening;
wherein a bottom surface of the top wall is comprised of an air flow channel; and
a camera adapter attached to the top wall, wherein the camera adapter is comprised of a first fastener a first leg, and a second leg spaced apart from the first leg.

15. The trail camera cover device of claim 14, wherein the air flow channel is comprised of a linear channel, a curved channel, a serpentine channel, or a helical channel.

16. The trail camera cover device of claim 14, wherein the channel is positioned on the bottom surface in a grid pattern, a spiral pattern, a radial pattern, or an irregular pattern.

17. The trail camera cover device of claim 14, wherein the body is comprised of a convex, circular shape.

18. The trail camera cover device of claim 14, wherein the top wall or the camera adapter is comprised of an opening.

19. The trail camera cover device of claim 18, wherein a strap is positioned through the opening.

20. The trail camera cover device of claim 19, wherein the strap is comprised of an adjustment fastener.
